(19) United States
(12) Patent Application Publication
(10) Pub. No.: US 2025/0042122 A1
(43) Pub. Date: Feb. 6, 2025

(54) RUBBER COMPOSITION, MULTILAYER STRUCTURE, AND HOSE

(71) Applicant: THE YOKOHAMA RUBBER CO., LTD., HIRATSUKA-SHI (JP)

(72) Inventors: Yuki MIZUTANI, HIRATSUKA SHI, KANAGAWA (JP); Hideyuki OISHI, HIRATSUKA SHI, KANAGAWA (JP)

(21) Appl. No.: 18/791,638

(22) Filed: Aug. 1, 2024

(30) Foreign Application Priority Data
Aug. 2, 2023 (JP) 2023-126018

(51) Int. Cl. B32B 1/08; B32B 25/08; B32B 25/10; B32B 25/14

(52) U.S. Cl. CPC B32B 1/08; B32B 25/08; B32B 25/10; B32B 25/14; B32B 2250/04; B32B 2262/0284

(57) ABSTRACT

An object of the present invention is to provide a rubber composition excellent in compression set resistance of the obtained rubber layer, adhesiveness between a resin layer and the rubber layer, and a maintaining property of strength of a reinforcing layer adjacent to the rubber layer. A rubber composition including: from 1 to 15 parts by mass of a phenolic resin; and 0.05 parts by mass or more and less than 1 part by mass of fatty acid, relative to 100 parts by mass of a rubber component containing from 30 to 100 parts by mass of a bromide of a copolymer rubber of an isomonoolefin and a p-alkylstyrene, from 0 to 70 parts by mass of a halogenated butyl rubber, and from 0 to 70 parts by mass of a butyl rubber, and a multilayer structure and a hose containing the same.

### TECHNICAL FIELD

The present invention relates to a rubber composition, a multilayer structure, and a hose.

### BACKGROUND ART

In the related art, as a refrigerant-transporting hose (for example, an air conditioner hose), for example, a hose has been known, which includes: an innermost layer that is a resin layer containing polyamide and having a low gas permeability, a rubber layer formed on the innermost layer by a rubber composition containing a butyl-based rubber and a resin crosslinking agent (for example, a phenolic resin); a reinforcing layer formed by, for example, a synthetic resin fiber on the rubber layer; and an outer tube on the reinforcing layer (for example, Patent Document 1).

### CITATION LIST

### Patent Document

Patent Document 1: JP 2002-79614 A

### SUMMARY OF INVENTION

### Technical Problem

In order to suppress leakage of an internal fluid (for example, chlorofluorocarbon gas), the refrigerant-transporting hose is required to include an innermost layer having a high refrigerant permeation resistance, a rubber layer having excellent compression set resistance, and to have excellent adhesiveness between the resin layer which is the innermost layer and the rubber layer on the innermost layer.

In addition, the reinforcing layer is required to have high strength so that the refrigerant-transporting hose can withstand high pressure.

In such circumstances, the present inventors prepared and evaluated a rubber composition with reference to Patent Document 1. However, they found that, in such a rubber composition, at least one of compression set resistance of the obtained rubber layer, adhesiveness between a resin layer and the rubber layer, and a maintaining property of strength of a reinforcing layer adjacent to the rubber layer may be deteriorated.

The present inventors have considered that, regarding a decrease in the strength of the reinforcing layer adjacent to the rubber layer, when the rubber layer is formed of a rubber composition containing a butyl-based rubber, a fatty acid (for example, stearic acid) as a processing aid, and a resin crosslinking agent, and the reinforcing layer is formed of a synthetic resin fiber, the fatty acid (for example, stearic acid) and the resin crosslinking agent deteriorate the synthetic resin fiber. The deterioration of the synthetic resin fiber as described above is considered to decrease the product life of the hose.

Accordingly, an object of the present invention is to provide a rubber composition excelling in compression set resistance of the obtained rubber layer, adhesiveness between a resin layer and the rubber layer, and a maintaining property of strength of a reinforcing layer adjacent to the rubber layer.

Another object of the present invention is to provide a multilayer structure and a hose.

### Solution to Problem

As a result of diligent studies to solve the above problems, the present inventors found that a decrease of an amount of a fatty acid or a phenolic resin that is a resin crosslinking agent in a rubber composition can suppress deterioration of a fiber layer (fiber reinforced layer) even if the rubber composition includes the fatty acid and the resin crosslinking agent. In addition, they found that a desired effect can be obtained by a rubber composition including: from 1 to 15 parts by mass of a phenolic resin; and 0.05 parts by mass or more and less than 1 part by mass of a fatty acid, relative to 100 parts by mass of a rubber component containing from 30 to 100 parts by mass of a bromide of a copolymer rubber of an isomonoolefin and a p-alkylstyrene, from 0 to 70 parts by mass of a halogenated butyl rubber, and from 0 to 70 parts by mass of a butyl rubber, and completed the present invention.

An embodiment of the present invention is based on the findings described above, and specifically solves the problems described above by the following configurations.

[1] A rubber composition including:
from 1 to 15 parts by mass of a phenolic resin; and
0.05 parts by mass or more and less than 1 part by mass of a fatty acid,
relative to 100 parts by mass of a rubber component containing from 30 to 100 parts by mass of a bromide of a copolymer rubber of an isomonoolefin and a p-alkylstyrene, from 0 to 70 parts by mass of a halogenated butyl rubber, and from 0 to 70 parts by mass of a butyl rubber.

[2] The rubber composition according to [1],
wherein a content of the bromide is from 50 to 100 parts by mass relative to 100 parts by mass of the rubber component.

[3] The rubber composition according to [1] or [2],
wherein a content of the phenolic resin relative to 100 parts by mass of the rubber component is from 1 to 5 parts by mass.

[4] The rubber composition according to any one of [1] to [3],
wherein a content of the fatty acid relative to 100 parts by mass of the rubber component is 0.1 parts by mass or more and less than 1 part by mass.

[5] A multilayer structure including:
a resin layer;
a rubber layer; and
a fiber layer,
wherein the resin layer is a layer containing a modified polyamide of a polyamide and a carboxyl group-containing modified polyolefin,
the rubber layer is a layer formed by a cured product of the rubber composition described in any one of [1] to [4], and
the fiber layer is a layer of a polyethylene terephthalate fiber.

[6] A hose including:
a resin layer;
a rubber layer 1;
a fiber reinforced layer; and
a rubber layer 2,
in this order from an innermost layer,
wherein the resin layer is a layer containing a modified polyamide of a polyamide and a carboxyl group-containing modified polyolefin,
the rubber layer 1 is a layer formed by a cured product of the rubber composition described in any one of [1] to [4], and
the fiber reinforced layer is a layer of a polyethylene terephthalate fiber.

### Advantageous Effects of Invention

According to the present invention, it is possible to provide a rubber composition excelling in compression set resistance of the obtained rubber layer, adhesiveness between a resin layer and the rubber layer, and a maintaining property of strength of a reinforcing layer adjacent to the rubber layer.

The present invention can also provide a multilayer structure and a hose.

### BRIEF DESCRIPTION OF DRAWINGS

FIG. 1 is a schematic perspective view showing an example of a hose of the present invention with each layer cut out.

### DESCRIPTION OF EMBODIMENTS

Embodiments of the present invention will be described in detail below.

In the present specification, a numerical range represented by using “(from) . . . to . . . ” includes the number before “to” and the number after “to”.

In the present specification, the production method of each component is not particularly limited unless otherwise noted. Examples of the method include a known method.

In the present specification, unless otherwise indicated, a substance corresponding to each component can be used alone or two or more types of substances can be used in combination. In a case where a component includes two or more types of substances, a content of the component means the total content of the two or more types of substances.

In the present specification, “bromide of a copolymer rubber of an isomonoolefin and a p-alkylstyrene” is also referred to as a “specific bromide”.

In the present specification, a case where at least one of compression set resistance of the obtained rubber layer, adhesiveness between a resin layer and the rubber layer, and a maintaining property of strength of a reinforcing layer adjacent to the rubber layer is more excellent may be referred to as “more excellent effect of the present invention”.

### Rubber Composition

A rubber composition of the present invention includes:
from 1 to 15 parts by mass of a phenolic resin; and
0.05 parts by mass or more and less than 1 part by mass of a fatty acid,
relative to 100 parts by mass of a rubber component containing from 30 to 100 parts by mass of a bromide of a copolymer rubber of an isomonoolefin and a p-alkylstyrene (a specific bromide), from 0 to 70 parts by mass of a halogenated butyl rubber, and from 0 to 70 parts by mass of a butyl rubber.

The rubber composition according to the present invention is thought to achieve the desired effects as a result of having such a configuration. Regarding the fact that the maintaining property of strength of the reinforcing layer adjacent to the rubber layer is excellent, it is presumed that the attack (for example, hydrolysis) of the fatty acid and/or the phenolic resin on the fiber layer (fiber reinforced layer) is decreased by setting the contents of the fatty acid and the phenolic resin contained in the rubber composition to the predetermined ranges.

Each of the components contained in the rubber composition according to the present invention will be described in detail below.

### Rubber Component

In the present invention, the rubber component contains from 30 to 100 parts by mass of a bromide of a copolymer rubber of an isomonoolefin and a p-alkylstyrene (specific bromide), from 0 to 70 parts by mass of a halogenated butyl rubber, and from 0 to 70 parts by mass of a butyl rubber, in 100 parts by mass of the rubber component.

### Specific Bromide

In the present invention, the bromide of the copolymer rubber of an isomonoolefin and a p-alkylstyrene (specific bromide) is not particularly limited.

Of all the repeating units constituting the specific bromide, which repeating unit is brominated is not particularly limited. In a preferred embodiment, some of the repeating units of the p-alkylstyrene of the copolymer rubber are brominated. That is, in the above case, the specific bromide can have, for example, repeating units of an isomonoolefin, repeating units of an unbrominated p-alkylstyrene, and repeating units of a brominated p-alkylstyrene.

### Isomonoolefin

The isomonoolefin constituting the specific bromide is a hydrocarbon compound having a C*—(CH₃)₂ branched structure at one end, and one double bond at another end. In a case where the isomonoolefin has 4 carbon atoms, the C* in the C*—(CH₃)₂ can form a double bond.

### Carbon Number

The carbon number of the isomonoolefin is preferably from 4 to 7, and more preferably 4, from the viewpoint of being more excellent in the effect of the present invention.

Examples of the isomonoolefin include isobutylene (isobutene, 2-methyl-1-propene), 3-methyl-1-butene (isopentene), 4-methyl-1-pentene (isohexene), and 5-methyl-1-hexene (isoheptene).

Among these, isobutylene is preferable as the isomonoolefin, from the viewpoint of achieving the more excellent effect of the present invention.

p-Alkylstyrene

The p-alkylstyrene constituting the specific bromide is a styrene having an alkyl group at the p-position.

As a preferred embodiment, in the specific bromide, some of the repeating units of the p-alkylstyrene are brominated in the alkyl group of the p-alkylstyrene.

Examples of the alkyl group contained in the p-alkylstyrene include an alkyl group having 1 to 8 carbon atoms such as a methyl group and an ethyl group.

Among these, the p-alkylstyrene is preferably p-methylstyrene from the viewpoint of achieving the more excellent effect of the present invention.

### Content of Repeating Units Having Bromine

The content of the repeating units having bromine constituting the specific bromide is preferably from 0.8 to 1.5 mol % relative to the total amount of the repeating units constituting the specific bromide, from the viewpoint of achieving the more excellent effect of the present invention.

The specific bromide does not include a butyl rubber and a halogenated butyl rubber.

### Butyl Rubber

The butyl rubber contained in the rubber composition of the present invention is not particularly limited. For example, a general isobutylene-isoprene copolymer rubber can be used.

The content of isoprene in the butyl rubber can be, for example, from 0.6 to 3.0 mol % in the total amount of the repeating units constituting the butyl rubber.

The butyl rubber does not include the specific bromide and the halogenated butyl rubber.

### Halogenated Butyl Rubber

The halogenated butyl rubber contained in the rubber composition of the present invention is not particularly limited. Examples of the halogenated butyl rubber include a chlorinated butyl rubber and a brominated butyl rubber.

When the halogenated butyl rubber contains a chlorinated butyl rubber, the content of chlorine in the chlorinated butyl rubber can be from 1 to 2.5% by mass. The content of isoprene can be, for example, from 0.6 to 3.0 mol % in the total amount of repeating units constituting the chlorinated butyl rubber.

When the halogenated butyl rubber contains a brominated butyl rubber, the content of bromine in the brominated butyl rubber can be from 1 to 2.5% by mass. The content of isoprene can be, for example, from 0.6 to 3.0 mol % in the total amount of repeating units constituting the brominated butyl rubber.

The halogenated butyl rubber does not include the specific bromide and the butyl rubber.

### Content of Specific Bromide

In the present invention, the content of the specific bromide is from 30 to 100 parts by mass in 100 parts by mass of the rubber component.

The content of the specific bromide is preferably from 50 to 100 parts by mass, more preferably from 80 to 100 parts by mass, and still more preferably 100 parts by mass, in 100 parts by mass of the rubber component, from the viewpoint of achieving the more excellent effect of the present invention.

### Content of Halogenated Butyl Rubber

In the present invention, the content of the halogenated butyl rubber is from 0 to 70 parts by mass in 100 parts by mass of the rubber component.

The content of the halogenated butyl rubber is preferably from 0 to 50 parts by mass in 100 parts by mass of the rubber component, from the viewpoint of achieving the more excellent effect of the present invention.

### Content of Butyl Rubber

In the present invention, the content of the butyl rubber is from 0 to 70 parts by mass in 100 parts by mass of the rubber component.

The content of the butyl rubber is preferably from 0 to 50 parts by mass in 100 parts by mass of the rubber component, from the viewpoint of achieving the more excellent effect of the present invention.

### Total Content of Specific Bromide, Halogenated Butyl Rubber, and Butyl Rubber

The total content of the specific bromide, the halogenated butyl rubber, and the butyl rubber described above is preferably more than 80 parts by mass and 100 parts by mass or less, more preferably from 90 to 100 parts by mass, and still more preferably 100 parts by mass, in 100 parts by mass of the rubber component, from the viewpoint of achieving the more excellent effect of the present invention.

### Other Rubbers

When the total content of the specific bromide, the halogenated butyl rubber, and the butyl rubber described above is less than 100 parts by mass in 100 parts by mass of the rubber component, the rubber component may further contain a rubber other than the specific bromide, the halogenated butyl rubber, and the butyl rubber.

The content of EPDM (ethylene propylene diene copolymer rubber) as the other rubber can be 0 parts by mass or less than 20 parts by mass in 100 parts by mass of the rubber component, and 0 parts by mass is exemplified as a preferred embodiment.

### Phenolic Resin and Fatty Acid

The rubber composition of the present invention contains from 1 to 15 parts by mass of a phenolic resin relative to 100 parts by mass of the rubber component.

The rubber composition of the present invention contains 0.05 parts by mass or more and less than 1 part by mass of a fatty acid relative to 100 parts by mass of the rubber component.

### Phenolic Resin

Examples of the phenolic resin contained in the rubber composition of the present invention include an alkylphenol resin.

The phenolic resin contained in the rubber composition of the present invention can function as, for example, a crosslinking agent for the butyl rubber or a crosslinking aid for the specific bromide.

The phenolic resin preferably contains an alkylphenol resin and more preferably contains a brominated alkylphenol resin, from the viewpoint of achieving the more excellent effect of the present invention.

Examples of the alkylphenol resin include: condensation products of an alkylphenol and formaldehyde; and halogenated alkylphenol resins such as brominated alkylphenol resins.

Examples of the brominated alkylphenol resin include brominated alkylphenol formaldehyde resins (condensation product of a brominated alkylphenol and formaldehyde).

### Fatty Acid

In the present invention, a fatty acid refers to an aliphatic hydrocarbon compound having one carboxy group. The aliphatic hydrocarbon group contained in the fatty acid is not particularly limited. The aliphatic hydrocarbon group may be any one of a saturated aliphatic hydrocarbon group or an unsaturated aliphatic hydrocarbon group.

Examples of the fatty acid include those containing at least one kind of fatty acid having 14 to 18 carbon atoms in total. In the present specification, the case where the total number of carbon atoms of a fatty acid is ** may be indicated by “C**”.

Examples of the C14 fatty acids include saturated fatty acids such as myristic acid; and unsaturated fatty acids such as myristoleic acid.

Examples of the C16 fatty acids include saturated fatty acids such as palmitic acid; and unsaturated fatty acids such as palmitoleic acid.

Examples of the C18 fatty acids include saturated fatty acids such as stearic acid; and unsaturated fatty acids such as oleic acid and linoleic acid.

The fatty acid preferably contains a fatty acid having at least 18 carbon atoms in total, and more preferably contains stearic acid, from the viewpoint of achieving the more excellent effect of the present invention.

In addition, commercially available products of fatty acids may be used for the fatty acid. Examples of the commercially available products include fatty acids which are generally referred to simply as “stearic acid” and contain fatty acids such as C18 fatty acids, or stearic acids for industrial use. The stearic acids for industrial use are usually mixtures of C18 fatty acids (e.g. stearic acid and oleic acid), C16 fatty acids (e.g. palmitic acid and palmitoleic acid), C14 fatty acids (e.g. myristic acid and myristoleic acid), and the like.

Examples of the commercially available products of fatty acids include beads stearic acid (available from Nippon Oil & Fats Co., Ltd.), stearic acid YR (available from NOF Corporation), lunac YA (available from Kao Corporation), and stearic acid 50S (available from Nissin Chemical Co., Ltd.).

### Content of Phenolic Resin

The content of the phenolic resin relative to 100 parts by mass of the rubber component is preferably from 1 to 5 parts by mass from the viewpoint of achieving the more excellent effect of the present invention.

### Content of Fatty Acid

The content of the fatty acid relative to 100 parts by mass of the rubber component is preferably 0.1 parts by mass or more and less than 1 part by mass, and more preferably 0.3 parts by mass or more and less than 1 part by mass, from the viewpoint of achieving the more excellent effect of the present invention.

### Additives

The rubber composition of the present invention may further contain an additive, as necessary, as long as the effect of the present invention is not impaired.

Examples of the additive include carbon black; white fillers such as talc and silica; plasticizers such as paraffin oil; zinc oxide; and anti-aging agents.

### Carbon Black

The rubber composition of the present invention preferably further contains carbon black (CB). CB is not particularly limited. For example, known ones can be used.

### Dibutyl Phthalate Oil Absorption Number of Carbon Black

The dibutyl phthalate oil absorption number (DBP oil absorption number) of the CB is preferably from 15 to 80 ml/100 g, from the viewpoint of achieving the more excellent effect of the present invention.

The dibutyl phthalate oil absorption number (DBP oil absorption number) of the carbon black can be measured in accordance with JIS K 6217-4:2008 “Carbon black for rubber industry-Fundamental characteristics-Part 4: Determination of oil absorption number (OAN) and oil absorption number of compressed sample (COAN)”.

### Iodine Adsorption Amount of Carbon Black

The iodine adsorption amount of the CB is preferably from 10 to 40 mg/g from the viewpoint of achieving the more excellent effect of the present invention.

In the present invention, the iodine adsorption amount of carbon black can be measured in accordance with JIS K 6217-1:2008.

The CB preferably contains carbon black of FTF (Fine Thermal Furnace), GPF (General Purpose Furnace), or SRF (Semi-Reinforcing Furnace), and more preferably contains carbon black of FTF and/or SRF, from the viewpoint of achieving the more excellent effect of the present invention.

### Content of Carbon Black

The content of the CB is preferably from 40 to 200 parts by mass, and more preferably from 80 to 150 parts by mass, relative to 100 parts by mass of the rubber component, from the viewpoint of achieving the more excellent effect of the present invention.

### Silica

The rubber composition of the present invention may further contain silica, and preferably further contain silica from the viewpoint of achieving the more excellent effect of the present invention.

The silica that can be further contained in the rubber composition of the present invention is not particularly limited. Examples of the silica include natural silica, fused silica, amorphous silica, hollow silica, and fumed silica.

The content of the silica can be from 0 to 20 parts by mass, and is preferably from 1 to 10 parts by mass, relative to 100 parts by mass of the rubber component, from the viewpoint of achieving the more excellent effect of the present invention.

### Talc

The rubber composition of the present invention preferably further contains talc, from the viewpoint of achieving the more excellent effect of the present invention.

Talc is a mineral composed of magnesium hydroxide and silicate, and is a compound represented by Mg₃Si₄O₁₀ (OH)₂.

The content of talc is preferably from 10 to 80 parts by mass relative to 100 parts by mass of the rubber component from the viewpoint of achieving the more excellent effect of the present invention.

### Zinc Oxide

The rubber composition of the present invention preferably further contains zinc oxide (ZnO).

Zinc oxide can function as a crosslinking agent for the specific bromide.

Zinc oxide is not particularly limited. Examples thereof include known ones.

The content of zinc oxide is preferably from 0.5 to 10 parts by mass, and more preferably from 1 to 5 parts by mass, relative to 100 parts by mass of the rubber component, from the viewpoint of achieving the more excellent effect of the present invention.

### Method for Producing Rubber Composition

The production method of the rubber composition of the present invention is not particularly limited. For example, the rubber composition can be produced by mixing the above-mentioned essential components and optional components that can be used if necessary under the conditions of 20 to 180° C.

### Crosslinking of Rubber Composition

The method for crosslinking the rubber composition of the present invention is not particularly limited. The rubber composition of the present invention can be crosslinked (vulcanized) by subjecting it to press vulcanization, steam vulcanization, oven vulcanization (hot-air vulcanization), or vulcanization with hot water under the conditions of, for example, from 140 to 190° C. and an applied pressure of from 1.0 to 4.0 MPa.

In the present invention, crosslinking the rubber composition of the present invention means crosslinking and curing the (uncrosslinked) rubber composition of the present invention. Specifically, the rubber component contained in the rubber composition of the present invention may be crosslinked. In the present specification, crosslinking may be referred to as vulcanization for the sake of convenience.

### Application

Since the rubber composition of the present invention provides excellent maintaining property of strength of the reinforcing layer (for example, a fiber layer of a synthetic resin or a fiber reinforced layer) adjacent to the obtained rubber layer, it can be used adjacent to the reinforcing layer.

The rubber composition of the present invention can be used for, for example, a hose, and specifically for, for example, a refrigerant-transporting hose.

### Multilayer Structure

A multilayer structure of the present invention includes: a resin layer; a rubber layer; and a fiber layer,
wherein the resin layer is a layer containing a modified polyamide of a polyamide and a carboxyl group-containing modified polyolefin,
the rubber layer is a layer formed by a cured product of the rubber composition of the present invention, and
the fiber layer is a layer of a polyethylene terephthalate fiber.

In the multilayer structure of the present invention, the resin layer, the rubber layer, and the fiber layer are adjacently laminated in the order of the resin layer, the rubber layer, and the fiber layer.

### Resin Layer

The resin layer included in the multilayer structure of the present invention is a layer containing a modified polyamide of a polyamide and a carboxyl group-containing modified polyolefin.

Examples of the polyamide include polyamide resins such as nylon 11, nylon 12, nylon 6, nylon 66, nylon 666, nylon 612, nylon 610, nylon 46, and nylon 66612.

The carboxyl group-containing modified polyolefin is a modified polyolefin that has a carboxyl group (—COOH).

The modified polyamide can be obtained by, for example, blending the polyamide and the carboxyl group-containing modified polyolefin.

Examples of the commercially available products of the modified polyamide include Zytel ST series products such as Zytel ST801, Zytel ST811, and Zytel ST811HS (available from DuPont).

The resin layer may further contain, for example, an additive in addition to the modified polyamide. Examples of the additive include carbon black, white fillers such as silica, vulcanizing agents or crosslinking agents, vulcanization accelerators or crosslinking accelerators, oils, and anti-aging agents. The content of the above-mentioned additive can be appropriately selected within the range not deviating from the object of the present invention.

The resin layer may be a layer formed of a resin composition further containing, for example, an additive in addition to the modified polyamide.

### Rubber Layer

The rubber layer contained in the multilayer structure of the present invention is a layer formed by a cured product of the rubber composition of the present invention.

The rubber composition used in the rubber layer is not particularly limited as long as it is the rubber composition of the present invention.

### Fiber Layer

The fiber layer contained in the multilayer structure of the present invention is a layer of a polyethylene terephthalate (PET) fiber.

The fiber layer may be a layer formed of the PET fiber.

Examples of the polyethylene terephthalate (PET) fiber forming the fiber layer include untreated PET fiber and PET fiber treated with RFL (resorcin-formaldehyde-latex adhesive).

Examples of the form of the fiber layer include those braided into a spiral structure or a braid structure.

### Additional Rubber Layer on Fiber Layer

The multilayer structure of the present invention may further include a rubber layer or the like on the fiber layer. When the rubber layer is further provided on the fiber layer, the additional rubber layer on the fiber layer is not particularly limited. Examples thereof include known rubber layers. Specific examples of the additional rubber layer on the fiber layer include a rubber layer having excellent weather resistance as one of preferable embodiments. The additional rubber layer on the fiber layer may be a layer formed by a cured product of the rubber composition of the present invention. In this case, the rubber layer on the resin layer and the additional rubber layer on the fiber layer may be the same or different.

### Method for Producing Multilayer Structure

Examples of the method for producing the multilayer structure of the present invention include a method in which the resin composition for the resin layer, the rubber composition of the present invention, and the PET fiber for the fiber layer are laminated in this order and heated in the laminated state, to thereby produce the multilayer structure of the present invention. The resin composition, the rubber composition of the present invention, and the fiber layer can be integrated by heating them in a state of being laminated as described above.

When the multilayer structure of the present invention further includes a rubber layer or the like on the fiber layer, a material corresponding to the rubber layer or the like may be further used.

As the heating conditions, for example, placement under the conditions of a temperature of from 140 to 190° C. and an applied pressure of 1.0 to 4.0 MPa for 30 to 180 minutes is exemplified.

The multilayer structure of the present invention can be applied for, for example, a hose, and specifically for, for example, a refrigerant-transporting hose.

The multilayer structure of the present invention can be used as, for example, a part of a hose.

### Hose

A hose of the present invention includes: a resin layer; a rubber layer 1; a fiber reinforced layer; and a rubber layer 2, in this order from an innermost layer,
wherein the resin layer is a layer containing a modified polyamide of a polyamide and a carboxyl group-containing modified polyolefin,
the rubber layer 1 is a layer formed by a cured product of the rubber composition of the present invention, and
the fiber reinforced layer is a layer of a polyethylene terephthalate fiber.

The hose of the present invention includes a resin layer, a rubber layer 1, a fiber reinforced layer, and a rubber layer 2 in this order from the innermost layer. In the hose of the present invention, the resin layer, the rubber layer 1, the fiber reinforced layer, and the rubber layer 2 are laminated adjacent to each other in this order from the innermost layer. The resin layer is the innermost layer.

### Resin Layer

The hose of the present invention includes a resin layer as an innermost layer. The resin layer in the hose of the present invention corresponds to and is the same as the resin layer in the multilayer structure of the present invention.

The thickness of the resin layer is not particularly limited, and may be, for example, from 0.05 to 0.30 mm.

### Rubber Layer 1

The hose of the present invention includes a rubber layer 1. The rubber layer 1 in the hose of the present invention corresponds to and is the same as the rubber layer adjacent to the resin layer in the multilayer structure of the present invention.

The thickness of the rubber layer 1 is not particularly limited, and may be, for example, from 0.2 to 3 mm.

### Fiber Reinforced Layer

The hose of the present invention includes a fiber reinforced layer. The fiber reinforced layer in the hose of the present invention corresponds to and is the same as the fiber layer in the multilayer structure of the present invention.

The thickness of the fiber reinforced layer is not particularly limited, and may be, for example, from 0.3 to 3 mm.

### Rubber Layer 2

The hose of the present invention includes a rubber layer 2. The rubber layer 2 in the hose of the present invention corresponds to and is the same as the additional rubber layer on the fiber layer in the multilayer structure of the present invention.

The thickness of the rubber layer 2 is not particularly limited, but may be, for example, from 0.2 to 3 mm.

In the hose of the present invention, the rubber layer 2 may be the outermost layer.

Next, a description of the structure of the hose of the present invention will be given while referring to the attached drawing. The present invention is not limited to the attached drawings. The reference signs shown in the drawings are described in parentheses in the following description.

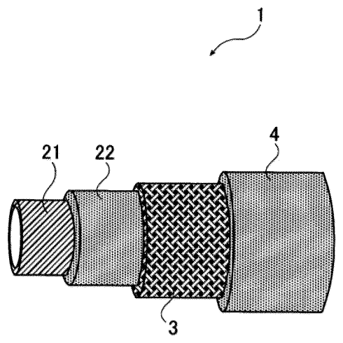

FIG. 1 is a schematic perspective view showing an example of a hose of the present invention with each layer cut out.

In FIG. 1, a hose (1) includes a resin layer (21), a rubber layer 1 (22), a fiber reinforced layer (3), and a rubber layer 2 (4).

The rubber layer 1 (22) is a rubber layer formed by the rubber composition of the present invention.

The rubber layer 2 (4) is not particularly limited. Examples thereof include known rubber layers. Specific examples of the rubber layer 2 (4) include a rubber layer having excellent weather resistance as one of preferable embodiments. The rubber layer 2 (4) may be a layer formed by a cured product of the rubber composition of the present invention. In this case, the rubber layer 1 (22) and the rubber layer 2 (4) may be the same or different.

### Method for Producing Hose

The method of producing the hose of the present invention is not particularly limited. For example, the hose of the present invention can be produced in the following manner. For example, the resin composition for forming the resin layer, the composition of the present invention for forming the rubber layer 1, the PET fiber for forming the fiber reinforced layer, and the rubber composition for forming the rubber layer 2 are laminated on a mandrel to form a multilayer structure so as to form a desired form of the hose. Then, the multilayer structure is integrated by crosslinking (vulcanizing) the multilayer structure through press vulcanization, steam vulcanization, oven vulcanization (hot-air vulcanization), or vulcanization with hot water under the conditions of from 140 to 190° C. for 30 to 180 minutes.

In the above, the hose of the present invention may be produced by coating the multilayer structure before crosslinking with a protective film such as polymethyl terpene, crosslinking the coated multilayer structure as described above, and then peeling the protective film from the multilayer structure after crosslinking.

The hose of the present invention can be used as, for example, a refrigerant-transporting hose.

Specific applications of the hose of the present invention include, for example, a hose for a car air conditioner system and a hose for an indoor air conditioner system.

### Examples

An embodiment of the present invention will be described below in detail by way of examples. However, an embodiment of the present invention is not limited to such examples.

### Production of Rubber Composition

The components listed in the respective tables below were used in compositions (part by mass) listed in the same tables and mixed by an agitator, and thus each of the rubber compositions was produced.

### Evaluation

The following evaluations were performed by using each of the rubber compositions produced as described above. The results are listed in Table 1.

### Compression Set Resistance of Rubber Layer

Each of the obtained rubber compositions was subjected to press vulcanization using a press molding machine with a mold having a diameter of 29.05 mm and a thickness of 12.5 mm under the conditions of 153° C. and a surface pressure of 3.5 MPa for 45 minutes, to prepare a disc-shaped test piece (the disc-shaped test piece had a diameter of 29.0±0.5 mm and a thickness of 12.5±0.5 mm).

The test piece was used to perform the compression set test under the conditions of a test temperature of 70° C., a test time of 22 hours, and a compression ratio of 25% according to JIS K6262: 2013, to measure a compression set (%). The results of the compression set were listed in each table with the result of Example 9 being indicated as 1.0.

### Evaluation Criteria of Compression Set

In the present invention, when the compression set (index) was 2.5 or less, the compression set resistance of the obtained rubber layer was evaluated as excellent and was indicated as “o”. An excellent compression set resistance of the rubber layer means excellent sealing properties of the multilayer structure or the hose. As the compression set (index) is less than 2.5, the compression set resistance of the rubber layer is more excellent.

On the other hand, when the compression set (index) was more than 2.5, the compression set resistance of the obtained rubber layer was evaluated as poor and was indicated as “x”.

### Adhesiveness Between Resin Layer and Rubber Layer

### Production of Sample

Each of the obtained rubber compositions as described above was formed into two unvulcanized rubber sheets each having a thickness of 2 mm.

Next, the modified polyamide (an alloy obtained by blending polyamide 6 and a carboxyl group-containing modified polyolefin was formed into a sheet-shaped product having a thickness of 0.2 mm) was sandwiched between the two unvulcanized rubber sheets described above, to form a three-layer multilayer structure. The multilayer structure was subjected to press vulcanization under the conditions of 153° C. and a press pressure of 2 MPa for 45 minutes, to prepare a strip-shaped sample having a width of 25 mm and a length of 150 mm.

### Measurement of the Peel Strength

Using a STROGRAPH E3-L (Toyo Seiki Seisaku-sho, Ltd.), one vulcanized rubber layer and the remaining two layers were each gripped at one end (one end having a width of 25 mm) of the sample obtained as described above and pulled up and down at a peeling rate of 50 mm/min to measure a peel strength. The obtained peel strength was divided by 25 to calculate an average value (unit: N/mm) of the peel strength, and the average value is listed in the column of “peel strength (average)” in each table.

### Evaluation Criteria of Peel Strength

In the present invention, when the peel strength obtained as described above was more than 1.0 N/mm, the adhesiveness between the resin layer and the rubber layer was evaluated as excellent and was indicated as “◯”. As the peel strength is larger than 1.0 N/mm, the adhesiveness between the resin layer and the rubber layer is more excellent.

On the other hand, when the peel strength obtained as described above was 1.0 N/mm or less, the adhesiveness between the resin layer and the rubber layer was evaluated as poor and was indicated as “x”.

### Maintaining Property of Strength of Reinforcing Layer Adjacent to Rubber Layer

### Production of Sample

On a mandrel made of iron having an outer diameter of 35 mm, an unvulcanized sheet having a thickness of 2.5 mm and prepared from each of the rubber compositions as described above was wound. Next, a twisted yarn of a polyethylene terephthalate fiber (without RFL treatment) was spirally wound to form a fiber reinforced layer. Next, the same unvulcanized sheet as the above-mentioned unvulcanized sheet was adhered again on the fiber reinforced layer to prepare an unvulcanized hose-shaped test piece.

Next, a curing tape (protective cloth) made of nylon 66 was wound so as to cover the outside of the unvulcanized hose-shaped test piece prepared as described above, and was subjected to oven vulcanization for 100 minutes under the condition of 160° C. After vulcanization, the curing tape was removed to obtain a vulcanized hose-shaped test piece. The vulcanized hose-shaped test piece has a three-layer structure of a rubber layer, a fiber reinforced layer, and a rubber layer from the inner layer.

The rubber layer on the surface at a central portion in a longitudinal direction of the vulcanized hose-shaped test piece obtained as described above was cut out and peeled along the circumference of the hose to expose the fiber reinforced layer.

### Measurement of Strength of Reinforcing Layer

The fiber was taken out from the sample that was the hose-shaped test piece after vulcanization in which the fiber reinforced layer was exposed as described above. Then, the fiber taken out from the sample was pulled at a pulling rate of 300 mm/min using Autograph ASG-X (available from Shimadzu Corporation) to measure the strength of the fiber of the hose-shaped test piece after vulcanization.

On the other hand, regarding the strength of the fiber before vulcanization, the twisted yarn of the polyethylene terephthalate fiber was pulled as it was at a pulling rate of 300 mm/min using Autograph ASG-X (available from Shimadzu Corporation), and the strength of the fiber before vulcanization was measured.

The strength obtained as described above was applied to the following equation to determine the reduction rate of the strength of the fiber.

$$Reduction rate of strength of fiber ( \% ) = ( B - A ) / A \times 100$$

A: Strength of fiber before vulcanization
B: Strength of fiber of hose-shaped test piece after vulcanization

### Evaluation Criteria of Reduction Rate of Strength of Fiber

In the present invention, when the reduction rate obtained as described above was greater than-80% (reduction rate>−80%), the maintaining property of the strength of the reinforcing layer adjacent to the rubber layer was evaluated as excellent and was indicated as “◯”. As the reduction rate is larger than −80%, the maintaining property is more excellent.

On the other hand, when the reduction rate was −80% or less, the maintaining property was evaluated as poor and was indicated as “x”.

TABLE 1

| | Comparative | Example | Example | Example | Comparative | Example | Example |
|---|---|---|---|---|---|---|---|
| Table 1-1 | Example 1 | 1 | 2 | 3 | Example 2 | 4 | 5 |
| Specific bromide (BIMS) | 20 | 30 | 30 | 50 | 100 | 100 | 100 |
| Br-IIR | | | 20 | | | | |
| IIR | 80 | 70 | 50 | 50 | | | |
| Carbon black | 120 | 120 | 120 | 120 | 120 | 120 | 120 |
| Silica | | | | | | | |
| Talc | 30 | 30 | 30 | 30 | 30 | 30 | 30 |
| Fatty acid | 0.5 | 0.5 | 0.5 | 0.5 | 0 | 0.05 | 0.05 |
| Phenolic resin | 5 | 5 | 5 | 5 | 0 | 1 | 15 |
| Paraffin oil | 5 | 5 | 5 | 5 | 5 | 5 | 5 |
| ZnO | 2 | 2 | 2 | 2 | 2 | 2 | 2 |

Compression set resistance of rubber layer: compression set:
Vulcanizing condition [153° C. × 45 min],
test temperature [RT], treatment temperature [70° C.],
treatment time [22 hr], compression ratio [25%]

| | | | | | | | |
|---|---|---|---|---|---|---|---|
| Compression set: index | 1.2 | 1.2 | 1.4 | 1.3 | 4.0 | 1.5 | 2.1 |
| indication | | | | | | | |
| Determination (∘ if 2.5 or less) | ∘ | ∘ | ∘ | ∘ | x | ∘ | ∘ |

Adhesiveness between resin
layer and rubber layer

| | | | | | | | |
|---|---|---|---|---|---|---|---|
| Peel strength (average) (N/mm) | 0.9 | 1.1 | 1.2 | 1.5 | 0.9 | 1.7 | 2.0 |
| Determination (∘ if more than 1.0) | x | ∘ | ∘ | ∘ | x | ∘ | ∘ |

Maintaining property of strength of reinforcing layer:
Strength reduction rate (after SW RT peeling: vs.
PET fiber)

| | | | | | | | |
|---|---|---|---|---|---|---|---|
| Reduction rate of strength of | −8 | −14 | −15 | −15 | −4 | −7 | −42 |
| fiber (%) | | | | | | | |
| Determination (∘ if more than −80%) | ∘ | ∘ | ∘ | ∘ | ∘ | ∘ | ∘ |

TABLE 2

| | Example | Example | Example | Example | Example | Example | Example | Example | Example |
|---|---|---|---|---|---|---|---|---|---|
| Table 1-2 | 6 | 7 | 8 | 9 | 10 | 11 | 8 | 12 | 13 |
| Specific bromide | 100 | 100 | 100 | 100 | 100 | 100 | 100 | 100 | 100 |
| (BIMS) | | | | | | | | | |
| Br-IIR | | | | | | | | | |
| IIR | | | | | | | | | |
| Carbon black | 120 | 120 | 120 | 120 | 120 | 120 | 120 | 120 | 120 |
| Silica | | | | | | | | | 5 |
| Talc | 30 | 30 | 30 | 30 | 30 | 30 | 30 | 30 | 30 |
| Fatty acid | 0.3 | 0.5 | 0.9 | 0.5 | 0.5 | 0.5 | 0.9 | 0.9 | 0.5 |
| Phenolic resin | 1 | 1 | 1 | 5 | 10 | 15 | 1 | 15 | 1 |
| Paraffin oil | 5 | 5 | 5 | 5 | 5 | 5 | 5 | 5 | 5 |
| ZnO | 2 | 2 | 2 | 2 | 2 | 2 | 2 | 2 | 2 |

Compression set resistance of rubber layer: compression set:
Vulcanizing condition [153° C. × 45 min],
test temperature [RT], treatment temperature [70° C.],
treatment time [22 hr], compression ratio [25%]

| | | | | | | | | | |
|---|---|---|---|---|---|---|---|---|---|
| Compression set: | 0.7 | 0.8 | 0.8 | 1.0 | 1.3 | 1.6 | 0.8 | 1.6 | 1.0 |
| index indication | | | | | | | | | |
| Determination (◯ if 2.5 or less) | ◯ | ◯ | ◯ | ◯ | ◯ | ◯ | ◯ | ◯ | ◯ |

Adhesiveness between
resin layer and rubber
layer

| | | | | | | | | | |
|---|---|---|---|---|---|---|---|---|---|
| Peel strength | 1.2 | 1.3 | 1.3 | 1.8 | 1.7 | 1.9 | 1.3 | 2.3 | 2.1 |
| (average) (N/mm) | | | | | | | | | |
| Determination (◯ if more than 1.0) | ◯ | ◯ | ◯ | ◯ | ◯ | ◯ | ◯ | ◯ | ◯ |

Maintaining property of strength of reinforcing layer:
Strength reduction rate (after SW RT peeling: vs. PET fiber)

| | | | | | | | | | |
|---|---|---|---|---|---|---|---|---|---|
| Reduction rate of | −19 | −22 | −28 | −36 | −53 | −71 | −28 | −74 | −12 |
| strength of fiber (%) | | | | | | | | | |
| Determination (◯ if more than −80%) | ◯ | ◯ | ◯ | ◯ | ◯ | ◯ | ◯ | ◯ | ◯ |

TABLE 3-1

| | Comparative | Comparative | Comparative | Comparative |
|---|---|---|---|---|
| Table 1-3 | Example 3 | Example 4 | Example 5 | Example 6 |
| Specific bromide (BIMS) | 100 | 100 | 100 | 100 |
| Br-IIR | | | | |
| IIR | | | | |
| Carbon black | 120 | 120 | 120 | 120 |
| Silica | | | | |
| Talc | 30 | 30 | 30 | 30 |
| Fatty acid | 1 | 0.9 | 1 | 0.3 |
| Phenolic resin | 15 | 16 | 1 | 0.5 |
| Paraffin oil | 5 | 5 | 5 | 5 |
| ZnO | 2 | 2 | 2 | 2 |

Compression set resistance of rubber layer: compression set: Vulcanizing condition [153° C. × 45 min],
test temperature [RT], treatment temperature [70° C.], treatment time [22 hr], compression ratio [25%]

| | | | | |
|---|---|---|---|---|
| Compression set: index indication | 1.7 | 1.7 | 0.8 | 0.7 |
| Determination (∘ if 2.5 or less) | ∘ | ∘ | ∘ | ∘ |

Adhesiveness between resin layer and rubber layer

| | | | | |
|---|---|---|---|---|
| Peel strength (average) (N/mm) | 2.2 | 2.2 | 1.2 | 0.9 |
| Determination (∘ if more than 1.0) | ∘ | ∘ | ∘ | x |

Maintaining property of strength of reinforcing layer: Strength reduction rate (after SW RT peeling: vs.
PET fiber)

| | | | | |
|---|---|---|---|---|
| Reduction rate of strength of fiber (%) | −86 | −88 | −80 | −19 |
| Determination (∘ if more than −80%) | x | x | x | ∘ |

TABLE 3-2

| | Comparative | Comparative | Comparative | Comparative |
|---|---|---|---|---|
| Table 1-3 | Example 7 | Example 8 | Example 9 | Example 10 |
| Specific bromide (BIMS) | 100 | 100 | 100 | 100 |
| Br-IIR | | | | |
| IIR | | | | |
| Carbon black | 120 | 120 | 120 | 120 |
| Silica | | | | |
| Talc | 30 | 30 | 30 | 30 |
| Fatty acid | 0.5 | 0.9 | 0 | 0.5 |
| Phenolic resin | 0.5 | 0.5 | 1 | 0 |
| Paraffin oil | 5 | 5 | 5 | 5 |
| ZnO | 2 | 2 | 2 | 2 |

Compression set resistance of rubber layer: compression set: Vulcanizing condition [153° C. × 45 min],
test temperature [RT], treatment temperature [70° C.], treatment time [22 hr], compression ratio [25%]

| | | | | |
|---|---|---|---|---|
| Compression set: index indication | 0.8 | 0.8 | 3.5 | 1.0 |
| Determination (∘ if 2.5 or less) | ∘ | ∘ | x | ∘ |

Adhesiveness between resin layer and rubber layer

| | | | | |
|---|---|---|---|---|
| Peel strength (average) (N/mm) | 0.9 | 0.9 | 1.0 | 0.8 |
| Determination (∘ if more than 1.0) | x | x | ∘ | x |

Maintaining property of strength of reinforcing layer: Strength reduction rate (after SW RT peeling: vs.
PET fiber)

| | | | | |
|---|---|---|---|---|
| Reduction rate of strength of fiber (%) | −22 | −27 | −20 | −23 |
| Determination (∘ if more than −80%) | ∘ | ∘ | ∘ | ∘ |

The details of each component listed in each table are as follows.

### Specific Bromide

Specific bromide (BIMS): Exxpro 3745, available from EXXONMOBIL CHEMICAL COMPANY A brominated copolymer rubber in which p-methylstyrene is brominated and converted into bromomethylstyrene in a copolymer rubber of an isomonoolefin (isobutylene) having 4 carbon atoms and p-methylstyrene. The content of the repeating units of the bromomethylstyrene was 1.2 mol % relative to the total amount of the repeating units constituting the BIMS.

### Halogenated Butyl Rubber

Br-IIR: brominated butyl rubber (bromobutyl rubber represented by the following formula) EXXON BROMOBUTYL 2255, available from Japan Butyl Co., Ltd. Since the brominated butyl rubber does not have repeating units of p-alkylstyrene, the brominated butyl rubber does not correspond to the specific bromide.

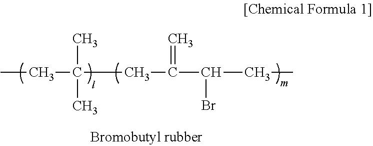

### Butyl Rubber

IIR: butyl rubber EXXON BUTYL 268, available from Japan Butyl Co., Ltd. Since the butyl rubber does not have repeating units of p-alkylstyrene, and is not brominated, the butyl rubber does not correspond to the specific bromide. Since the butyl rubber does not have a halogen, it does not correspond to a halogenated butyl rubber.

### Carbon Black

Carbon black: SRF carbon black DBP absorption number: 64±12 cm³/100 g, iodine adsorption amount: 23±5 mg/g.
Silica: Nipsil AQ (available from Tosoh Silica Corporation) acid silica
Talc: Mistron Vapor (available from Nihon Mistron Co., Ltd.)

### Fatty Acid

Fatty acid: stearic acid Product name: stearic acid: Stearic Acid 50S, available from Nissin Chemical Co., Ltd.

### Phenolic Resin

Phenolic resin: brominated alkylphenol formaldehyde resin Tucky Roll 250-I, manufactured by Taoka Chemical Co., Ltd.
Paraffin oil: machine oil, available from Showa Shell Sekiyu K. K.
ZnO: Zinc oxide Zinc Oxide III, available from Seido Chemical Industry Co., Ltd.

From the results listed in Table 1, in Comparative Example 1 in which the contents of the specific bromide and the butyl rubber were out of the predetermined ranges, the adhesiveness between the resin layer and the rubber layer was poor.

In Comparative Example 2 in which the phenolic resin and the fatty acid were not contained, the compression set resistance of the rubber layer and the adhesiveness between the resin layer and the rubber layer were poor.

In Comparative Examples 3 and 5 in which the fatty acid was contained in an amount of 1 part by mass, the maintaining property of the strength of the reinforcing layer was poor.

In Comparative Example 4 in which the phenolic resin was contained in an amount of 16 parts by mass, the maintaining property of the strength of the reinforcing layer was poor.

In Comparative Examples 6 to 8 in which the content of the phenolic resin was less than 1 part by mass, the adhesiveness between the resin layer and the rubber layer was poor.

In Comparative Example 9 in which no fatty acid was contained, the compression set resistance of the rubber layer was poor.

In Comparative Example 10 in which no phenolic resin was contained, the adhesiveness between the resin layer and the rubber layer was poor.

On the other hand, the rubber composition of the present invention was excellent in compression set resistance of the obtained rubber layer, adhesiveness between the resin layer and the rubber layer, and the maintaining property of strength of the reinforcing layer adjacent to the rubber layer.

The multilayer structure of the present invention is excellent in the compression set resistance of the rubber layer, the adhesiveness between the resin layer and the rubber layer, and the maintaining property of strength of the fiber layer adjacent to the rubber layer.

The hose of the present invention is excellent in compression set resistance of the rubber layer, adhesiveness between the resin layer and the rubber layer, and the maintaining property of strength of the fiber reinforced layer adjacent to the rubber layer.

### REFERENCE SIGNS LIST

1 Hose
21 Resin layer
22 Rubber layer 1
3 Fiber reinforced layer
4 Rubber layer 2

1. A rubber composition comprising:
from 1 to 15 parts by mass of a phenolic resin; and
0.05 parts by mass or more and less than 1 part by mass of a fatty acid,
relative to 100 parts by mass of a rubber component containing from 30 to 100 parts by mass of a bromide of a copolymer rubber of an isomonoolefin and a p-alkylstyrene, from 0 to 70 parts by mass of a halogenated butyl rubber, and from 0 to 70 parts by mass of a butyl rubber.

2. The rubber composition according to claim 1,
wherein a content of the bromide is from 50 to 100 parts by mass relative to 100 parts by mass of the rubber component.

3. The rubber composition according to claim 1,
wherein a content of the phenolic resin relative to 100 parts by mass of the rubber component is from 1 to 5 parts by mass.

4. The rubber composition according to claim 1,
wherein a content of the fatty acid relative to 100 parts by mass of the rubber component is 0.1 parts by mass or more and less than 1 part by mass.

5. A multilayer structure comprising:
a resin layer;
a rubber layer; and
a fiber layer,
the resin layer being a layer containing a modified polyamide of a polyamide and a carboxyl group-containing modified polyolefin,
the rubber layer being a layer formed by a cured product of the rubber composition described in claim 1, and
the fiber layer being a layer of a polyethylene terephthalate fiber.

6. A hose comprising:
a resin layer;
a first rubber layer;
a fiber reinforced layer; and
a second rubber layer,
in this order from an innermost layer,
the resin layer being a layer containing a modified polyamide of a polyamide and a carboxyl group-containing modified polyolefin,
the first rubber layer being a layer formed by a cured product of the rubber composition described in claim 1, and
the fiber reinforced layer being a layer of a polyethylene terephthalate fiber.

7. The rubber composition according to claim 2,
wherein a content of the phenolic resin relative to 100 parts by mass of the rubber component is from 1 to 5 parts by mass.

8. The rubber composition according to claim 2,
wherein a content of the fatty acid relative to 100 parts by mass of the rubber component is 0.1 parts by mass or more and less than 1 part by mass.

9. The multilayer structure according to claim 5,
wherein the rubber layer is the layer formed by the cured product of the rubber composition in which a content of the bromide is from 50 to 100 parts by mass relative to 100 parts by mass of the rubber component.

10. The hose according to claim 6,
wherein the first rubber layer is the layer formed by the cured product of the rubber composition in which a content of the bromide is from 50 to 100 parts by mass relative to 100 parts by mass of the rubber component.

11. The rubber composition according to claim 3,
wherein a content of the fatty acid relative to 100 parts by mass of the rubber component is 0.1 parts by mass or more and less than 1 part by mass.

12. The multilayer structure according to claim 5,
wherein the rubber layer is the layer formed by the cured product of the rubber composition in which a content of the phenolic resin relative to 100 parts by mass of the rubber component is from 1 to 5 parts by mass.

13. The hose according to claim 6,
wherein the first rubber layer is the layer formed by the cured product of the rubber composition in which a content of the phenolic resin relative to 100 parts by mass of the rubber component is from 1 to 5 parts by mass.

14. The multilayer structure according to claim 5,
wherein the rubber layer is the layer formed by the cured product of the rubber composition in which a content of the fatty acid relative to 100 parts by mass of the rubber component is 0.1 parts by mass or more and less than 1 part by mass.

15. The hose according to claim 6,
wherein the first rubber layer is the layer formed by the cured product of the rubber composition in which a content of the fatty acid relative to 100 parts by mass of the rubber component is 0.1 parts by mass or more and less than 1 part by mass.
